(19) United States
(12) Patent Application Publication
(10) Pub. No.: US 2023/0415263 A1
(43) Pub. Date: Dec. 28, 2023

(54) LASER PROCESSING APPARATUS

(71) Applicant: DISCO CORPORATION, Tokyo (JP)

(72) Inventor: Hiroshi MORIKAZU, Tokyo (JP)

(21) Appl. No.: 18/339,669

(22) Filed: Jun. 22, 2023

(30) Foreign Application Priority Data
Jun. 28, 2022 (JP) 2022-103417

(51) Int. Cl. B23K 26/08; B23K 26/082

(52) U.S. Cl. CPC B23K 26/0876; B23K 26/082

(57) ABSTRACT

A laser beam irradiation unit of a laser processing apparatus includes a laser oscillator that emits a laser beam, an X-axis galvano scanner that induces the laser beam emitted by the laser oscillator in an X-axis direction, a Y-axis galvano scanner that induces the laser beam in a Y-axis direction, and a controller that controls the X-axis galvano scanner and the Y-axis galvano scanner. The controller includes a processing region storing section that stores the X-coordinate and Y-coordinate of processing regions in which a workpiece held by a chuck table is processed and an order-of-processing storing section that stores setting of the order of processing of the processing region to be processed on a forward path through irradiation with the laser beam and the processing region of a return path to be subsequently processed.

### BACKGROUND OF THE INVENTION

### Field of the Invention

The present invention relates to a laser processing apparatus that irradiates a workpiece with a laser beam.

### Description of the Related Art

A wafer including multiple light emitting elements such as light emitting diodes (LED) or semiconductor lasers (LD: Laser Diode) includes an optical device layer formed of an n-type semiconductor layer and a p-type semiconductor layer composed of GaN, InGaP, AlGaN, or the like over the upper surface of an epitaxy substrate such as a sapphire substrate or SiC substrate with the interposition of a buffer layer, and is formed through marking out light emitting devices by multiple planned dividing lines that intersect.

Further, a technique is implemented in which a relocation substrate is disposed on the optical device layer side and irradiation with a laser beam with a wavelength having transmissibility with respect to the epitaxy substrate and having absorbability with respect to the buffer layer is executed from the epitaxy substrate side to break the buffer layer in the whole of the wafer and transfer the optical device layer from the epitaxy substrate to the relocation substrate (for example, refer to Japanese Patent Laid-open No. 2013-229336).

### SUMMARY OF THE INVENTION

In the technique described in the above-described Japanese Patent Laid-open No. 2013-229336, to efficiently break the buffer layer, the laser beam emitted by a laser oscillator needs to be moved at high speed by a galvano scanner. However, reciprocation operation is necessary to move the laser beam by the galvano scanner, and there is a problem that a load of an inertial force generated in the galvano scanner at turnarounds between processing of a forward path and processing of a return path lowers the lifetime of the galvano scanner.

Thus, an object of the present invention is to provide a laser processing apparatus that can resolve a problem that the lifetime of a galvano scanner lowers due to a load of an inertial force generated in the galvano scanner.

In accordance with an aspect of the present invention, there is provided a laser processing apparatus configured to include a chuck table having a holding surface that holds a workpiece and is defined by an X-axis direction and a Y-axis direction and a laser beam irradiation unit that irradiates the workpiece held by the chuck table with a laser beam. The laser beam irradiation unit includes a laser oscillator that oscillates the laser beam, an X-axis galvano scanner that induces the laser beam oscillated by the laser oscillator in the X-axis direction, a Y-axis galvano scanner that induces the laser beam in the Y-axis direction, and a controller that controls the X-axis galvano scanner and the Y-axis galvano scanner. The controller includes a processing region storing section that stores the X-coordinate and Y-coordinate of processing regions in which the workpiece held by the chuck table is processed and an order-of-processing storing section that stores setting of the order of processing of the processing region to be processed on a forward path through irradiation with the laser beam and the processing region of a return path to be subsequently processed. In the setting of the order of processing, the Y-coordinate of the return path is set in such a manner that a load generated in the X-axis galvano scanner that converts the movement direction of the laser beam is alleviated when processing is executed on the forward path in the X-axis direction by using the X-axis galvano scanner and subsequently processing is executed on the return path in the X-axis direction.

Preferably, in the setting of the order of processing, when the order of processing of the processing region of the return path is set, the processing region of the return path that is not adjacent to the processing region of the forward path to be processed immediately previously in the Y-axis direction is set. Preferably, in the setting of the order of processing, the processing region corresponding to the Y-coordinate of one endmost part is set as the first processing region in which the workpiece held by the chuck table is processed on the forward path, the processing region corresponding to the Y-coordinate of the other endmost part is set as the first processing region to be processed on the return path, the processing region adjacent to the inside of the processing region at the one endmost part in the Y-axis direction is set as the processing region to be processed on the next forward path, and the processing region adjacent to the inside of the processing region at the other endmost part in the Y-axis direction is set as the processing region to be processed on the next return path. Further, the processing regions that sequentially correspond to the inside of the workpiece in the Y-axis direction are set as the processing regions of the forward path and the processing regions of the return path.

Preferably, in the setting of the order of processing, the processing region corresponding to the Y-coordinate of one endmost part is set as the first processing region in which the workpiece held by the chuck table is processed on the forward path, the processing region corresponding to the Y-coordinate of a central part is set as the first processing region to be processed on the return path, the processing region adjacent to the inside of the processing region at the one endmost part in the Y-axis direction is set as the processing region to be processed on the next forward path, and the processing region adjacent to the other end part side of the processing region at the central part in the Y-axis direction is set as the processing region to be processed on the next return path. Further, the processing regions that sequentially correspond to the inside of the workpiece in the Y-axis direction are set as the processing regions of the forward path, and the processing regions that sequentially correspond to the other end part side of the workpiece are set as the processing regions of the return path.

According to the laser processing apparatus of the present invention, the problem that the lifetime of the X-axis galvano scanner lowers due to a load of an inertial force generated in the X-axis galvano scanner is resolved.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view of a wafer and a relocation substrate that configure a two-layer substrate that is a workpiece of the present embodiment;

FIG. 2 is a perspective view illustrating a form of holding the two-layer substrate in FIG. 1 by an annular frame;

FIG. 3 is an overall perspective view of a laser processing apparatus of the present embodiment;

FIG. 4 is a block diagram illustrating an optical system of a laser beam irradiation unit disposed in the laser processing apparatus illustrated in FIG. 3;

FIG. 5 is a conceptual diagram illustrating information stored in a processing region storing section and an order-of-processing storing section disposed in a controller; and

FIG. 6 is a partially enlarged sectional view illustrating an embodiment of laser processing executed by the laser processing apparatus of the present embodiment.

### DETAILED DESCRIPTION OF THE PREFERRED EMBODIMENT

A laser processing apparatus of an embodiment of the present invention will be described in detail below with reference to the accompanying drawings.

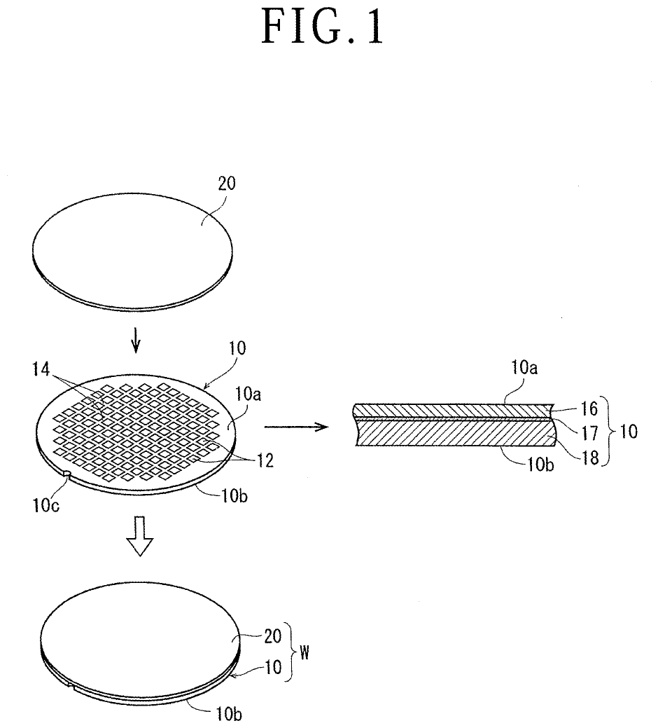

First, a workpiece to be processed by the laser processing apparatus of the present embodiment will be described with reference to FIG. 1. FIG. 1 illustrates a wafer 10 that configures a two-layer substrate W as the workpiece and a relocation substrate 20 bonded to a front surface 10a of the wafer 10. A partially enlarged sectional view of the wafer 10 is illustrated on the right side. As illustrated in the diagram, the wafer 10 includes an epitaxy substrate 18 and an optical device layer 16 formed over the upper surface of the epitaxy substrate 18 with the interposition of a buffer layer 17. In the present embodiment, description will be made below on the basis of the assumption that a sapphire substrate is employed as the epitaxy substrate 18. In the optical device layer 16, multiple light emitting devices 12 including an epitaxial layer formed of an n-type semiconductor layer and a p-type semiconductor layer (neither is illustrated) formed by epitaxial growth through the buffer layer 17 and electrodes (not illustrated) disposed on the n-type semiconductor layer and the p-type semiconductor layer are formed in such a manner as to be marked out by multiple planned dividing lines 14 that intersect.

The optical device layer 16 is composed of gallium nitride (GaN), for example. However, the present invention is not limited thereto, and the material of the optical device layer 16 can be selected from well-known semiconductors such as gallium phosphide (GaP) and indium arsenide (InAs). The buffer layer 17 is formed by the same kind of material as the above-described optical device layer 16. The relocation substrate 20 is formed from molybdenum, copper, silicon, or the like, for example, and is disposed to face the optical device layer 16 with the interposition of a joining metal layer selected from gold, platinum, chromium, indium, palladium, and so forth. In the wafer 10, a notch 10c that indicates the crystal orientation of the sapphire substrate that configures the epitaxy substrate 18 is formed.

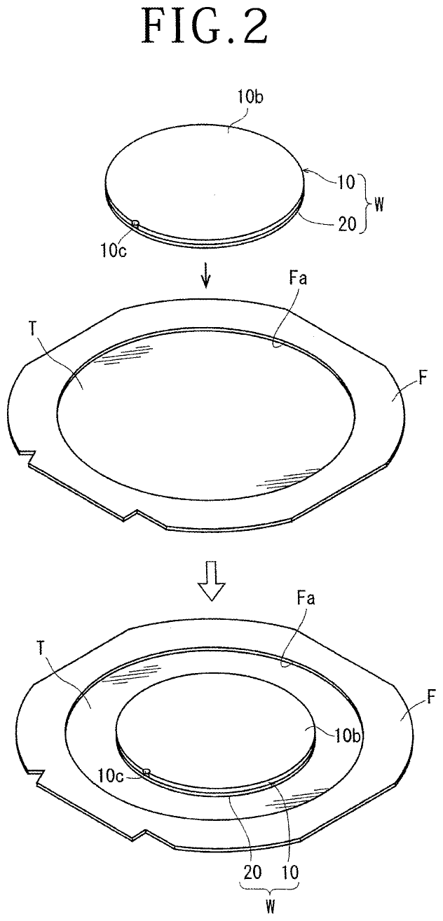

After the above-described two-layer substrate W is prepared, as illustrated in FIG. 2, an annular frame F having an opening Fa in which the two-layer substrate W can be housed is prepared. Then, the two-layer substrate W is positioned in a predetermined direction of the opening Fa on the basis of the above-described notch 10c with the side of a back surface 10b of the wafer 10 oriented upward and with the side of the relocation substrate 20 oriented downward. Then, the two-layer substrate W and the annular frame F are stuck to the protective tape T and are integrated as illustrated on the lower side of the diagram.

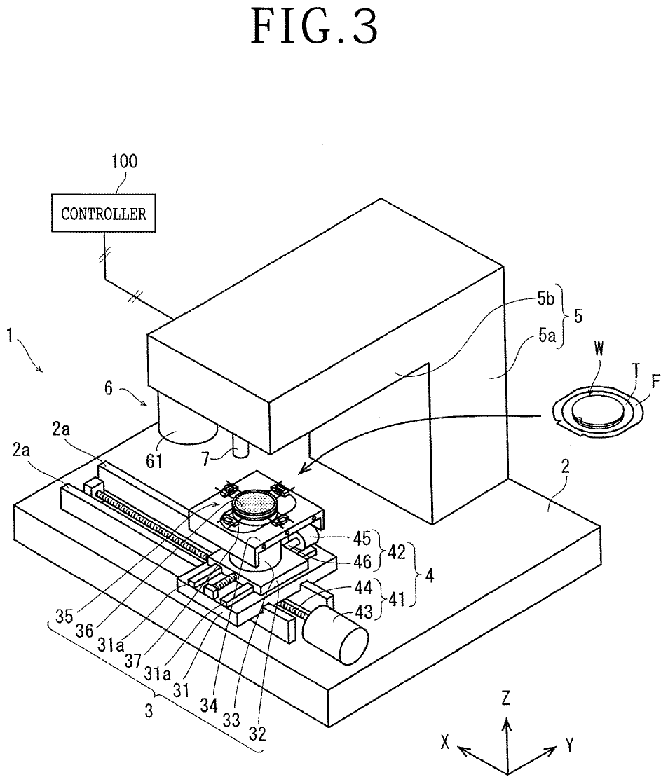

In FIG. 3, a laser processing apparatus 1 configured on the basis of the present invention in order to process the above-described two-layer substrate W is illustrated. The laser processing apparatus 1 includes a holding unit 3 that is disposed over the base 2 and includes a chuck table 35 having a holding surface 36 that holds the illustrated two-layer substrate W and is defined by an X-axis direction and a Y-axis direction, and a laser beam irradiation unit 6 that irradiates the two-layer substrate W held by the holding unit 3 with a laser beam.

The laser processing apparatus 1 further includes a movement mechanism 4 including an X-axis feed mechanism 41 that moves the chuck table 35 in the X-axis direction and a Y-axis feed mechanism 42 that moves the chuck table 35 in the Y-axis direction, a frame body 5 including a vertical wall part 5a erected on a lateral side of the movement mechanism 4 on the base 2 and a horizontal wall part 5b extending in the horizontal direction from an upper end part of the vertical wall part 5a, an imaging unit 7 that images the two-layer substrate W held by the chuck table 35 and executes alignment, and a controller 100. An input unit, a display unit, and so forth that are not illustrated are connected to the controller 100.

As illustrated in FIG. 3, the holding unit 3 includes a rectangular X-axis direction movable plate 31 mounted over the base 2 movably in the X-axis direction, a rectangular Y-axis direction movable plate 32 mounted over the X-axis direction movable plate 31 movably in the Y-axis direction, a circular cylindrical support column 33 fixed to the upper surface of the Y-axis direction movable plate 32, and a rectangular cover plate 34 fixed to the upper end of the support column 33. The chuck table 35 that passes through a long hole formed on the cover plate 34 and extends upward is disposed over the cover plate 34. The chuck table 35 is configured to be capable of rotating by a rotational drive mechanism that is housed in the support column 33 and is not illustrated. At the upper surface of the chuck table 35, the holding surface 36 that is formed of a porous material having gas permeability and is defined by the X-axis direction and the Y-axis direction is formed. The holding surface 36 is connected to suction means that is not illustrated by a flow path passing through the support column 33. A negative pressure can be generated at the holding surface 36 by actuating the suction means, and the two-layer substrate W can be held under suction. Around the holding surface 36, four clamps 37 used to fix the annular frame F when the two-layer substrate W is held over the chuck table 35 are disposed at equal intervals.

The X-axis feed mechanism 41 converts rotational motion of a motor 43 to linear motion through a ball screw 44 and transmits the linear motion to the X-axis direction movable plate 31 to move the X-axis direction movable plate 31 in the X-axis direction along a pair of guide rails 2a disposed along the X-axis direction on the base 2. The Y-axis feed mechanism 42 converts rotational motion of a motor 45 to linear motion through a ball screw 46 and transmits the linear motion to the Y-axis direction movable plate 32 to move the Y-axis direction movable plate 32 in the Y-axis direction along a pair of guide rails 31a disposed along the Y-axis direction on the X-axis direction movable plate 31.

An optical system that configures the above-described laser beam irradiation unit 6 and the imaging unit 7 are housed inside the horizontal wall part 5b of the frame body 5. A light collector 61 that configures part of the laser beam irradiation unit 6 and irradiates the two-layer substrate W with a laser beam LB is disposed on the lower surface side of a tip part of the horizontal wall part 5b.

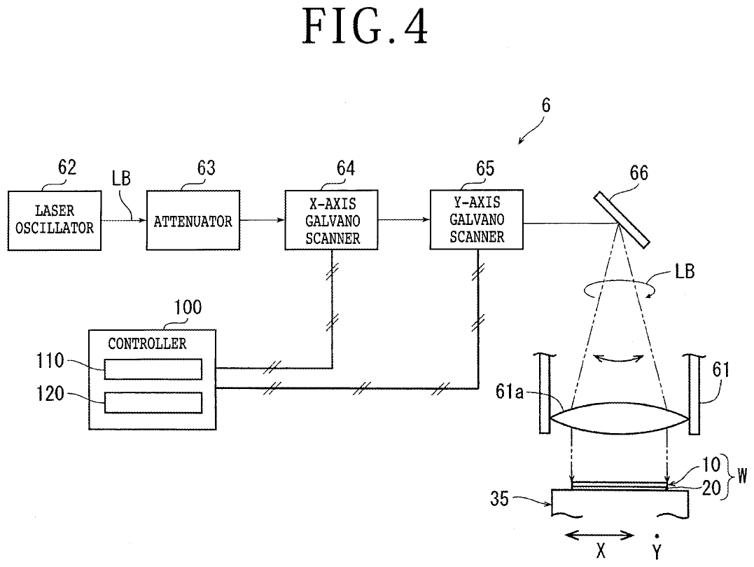

In FIG. 4, a block diagram illustrating one example of the optical system of the above-described laser beam irradiation unit 6 is illustrated. The laser beam irradiation unit 6 of the present embodiment includes a laser oscillator 62 that emits the laser beam LB and the light collector 61 including an fθ lens 61a. An X-axis galvano scanner 64 and a Y-axis galvano scanner 65 are disposed between the laser oscillator 62 and the fθ lens 61a. The X-axis galvano scanner 64 induces the laser beam LB in the X-axis direction of the two-layer substrate W held by the holding surface 36 of the chuck table 35. The Y-axis galvano scanner 65 induces the laser beam LB in the Y-axis direction of the two-layer substrate W held by the holding surface 36 of the chuck table 35. In the laser beam irradiation unit 6 of the present embodiment, moreover, an attenuator 63 that adjusts the output power of the laser beam LB emitted by the laser oscillator 62 and a reflective mirror 66 that changes the optical path of the laser beam LB to the side of the light collector 61 are disposed.

The controller 100 is configured by a computer and includes a central processing unit (CPU) that executes calculation processing in accordance with a control program, a read only memory (ROM) that stores the control program and so forth, a readable-writable random access memory (RAM) for temporarily storing a calculation result and so forth, an input interface, and an output interface. The laser beam irradiation unit 6 (X-axis galvano scanner 64 and Y-axis galvano scanner 65), the imaging unit 7, the X-axis feed mechanism 41, the Y-axis feed mechanism 42, and so forth are connected to the controller 100 and are controlled.

When the two-layer substrate W that is a workpiece is irradiated with the laser beam LB emitted by the laser oscillator 62 by the above-described laser beam irradiation unit 6, the chuck table 35 is positioned directly under the light collector 61 by controlling the above-described X-axis feed mechanism 41 and Y-axis feed mechanism 42, and the X-axis galvano scanner 64 and the Y-axis galvano scanner 65 are controlled by the controller 100. This makes it possible to precisely position the laser beam LB to a desired X-coordinate/Y-coordinate position on the two-layer substrate W held by the chuck table 35 and execute irradiation.

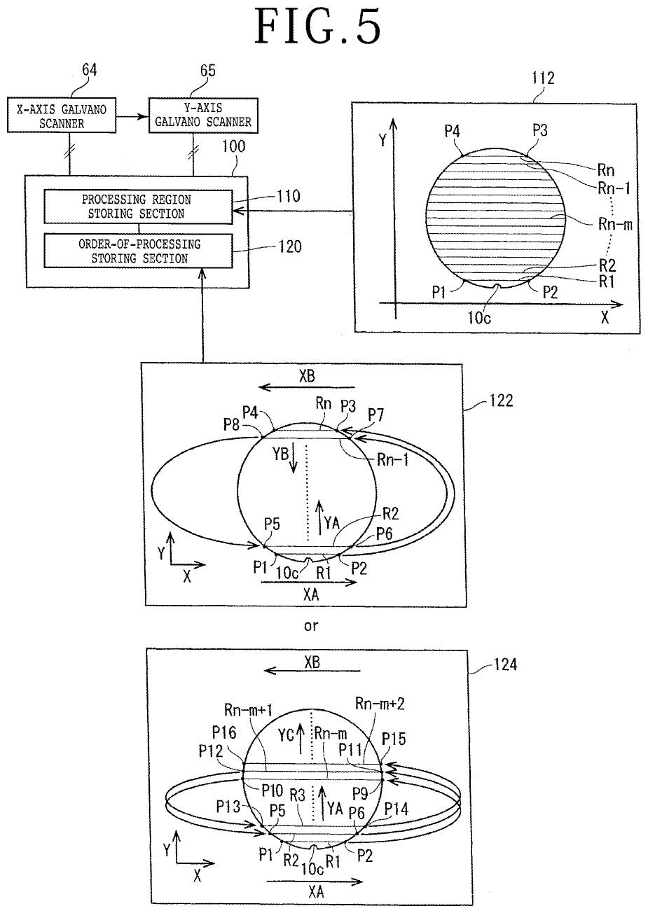

As illustrated in FIG. 5, the controller 100 includes a processing region storing section 110 that stores the X-coordinate and Y-coordinate of processing regions in which the two-layer substrate W held by the chuck table 35 of the holding unit 3 is processed and an order-of-processing storing section 120 that stores the order of processing of the processing region to be processed on a forward path through irradiation with the laser beam LB and the processing region of a return path to be subsequently processed. The processing region storing section 110 and the order-of-processing storing section 120 will be described more specifically below with reference to FIG. 5.

In the processing region storing section 110, processing region information 112 relating to the X-coordinate and Y-coordinate of processing regions R1 to Rn in which laser processing to break the buffer layer 17 through irradiation of the two-layer substrate W with the laser beam LB is executed, like one illustrated on the right side of FIG. 5, is stored. For example, the processing regions R1 to Rn are processing regions set along the X-axis direction in the two-layer substrate W when the notch 10c of the wafer 10 that configures the two-layer substrate W is positioned to the lower end position that is one end part in the Y-axis direction. The processing regions R1 to Rn are multiple (in the present embodiment, n) regions set at a predetermined interval in the Y-axis direction and are identified by the X-coordinate and Y-coordinate of both end parts of each processing region in the X-axis direction. For example, as illustrated in FIG. 5, the processing region R1 on the side of one endmost part (lowermost end part in the diagram) at which the notch 10c is positioned is identified by the X-coordinate and Y-coordinate of P1 and the X-coordinate and Y-coordinate of P2. The processing region Rn on the side of the other endmost part (uppermost end part in the diagram) is identified by the X-coordinate and Y-coordinate of P3 and the X-coordinate and Y-coordinate of P4. In FIG. 5, the interval of the respective processing regions R1 to Rn in the Y-axis direction is illustrated as a wide interval for convenience of explanation. Actually, the processing regions R1 to Rn are set at a shorter interval (for example, 500 μm).

The order-of-processing storing section 120 is what stores the order of processing of the processing region to be processed on a forward path through irradiation with the laser beam LB and the processing region of a return path to be subsequently processed regarding the respective processing regions R1 to Rn stored in the processing region storing section 110. For example, order-of-processing information 122 or order-of-processing information 124 like one illustrated on the lower side of FIG. 5 is stored. In the laser processing of the present embodiment, as illustrated in the order-of-processing information 122 and 124 in FIG. 5, the direction in which processing is executed with scanning with the laser beam LB in a direction indicated by an arrow XA will be referred to as the forward path, and the direction in which processing is executed with scanning with the laser beam LB in a direction indicated by an arrow XB will be referred to as the return path.

First, description will be made about the order-of-processing information 122 that illustrates one example relating to setting of the order of processing of the processing regions R1 to Rn. The first processing region in which the two-layer substrate W held by the chuck table 35 of the holding unit 3 is processed on the forward path is the processing region R1 corresponding to the Y-coordinate of the above-described one endmost part, and the first processing region to be processed on the return path is the processing region Rn corresponding to the Y-coordinate of the above-described other endmost part. At this time, in the order-of-processing information 122, the X-coordinate and Y-coordinate of the start end P1 of irradiation with the laser beam LB in the processing region R1 to be processed first on the forward path and the X-coordinate and Y-coordinate of the terminal end P2 thereof are set, and the X-coordinate and Y-coordinate of the start end P3 of irradiation with the laser beam LB in the processing region Rn to be processed first on the return path and the X-coordinate and Y-coordinate of the terminal end P4 thereof are set. Further, the processing region to be processed on the next forward path is the processing region R2 adjacent to the inside (direction indicated by an arrow YA) of the processing region R1 at the one endmost part in the Y-axis direction, and the X-coordinate and Y-coordinate of a start end P5 and a terminal end P6 of irradiation with the laser beam LB are set. The processing region to be processed on the next return path is the processing region Rn−1 adjacent to the inside (direction indicated by an arrow YB) of the processing region Rn at the other endmost part in the Y-axis direction, and the X-coordinate and Y-coordinate of a start end P7 and a terminal end P8 of irradiation with the laser beam LB are set. As the processing regions of the forward path and the processing regions of the return path to be processed subsequently to them, the processing regions that sequentially correspond to the inside (direction indicated by the arrow YA and direction indicated by the arrow YB) of the two-layer substrate W in the Y-axis direction are set, and information regarding the X-coordinate and Y-coordinate of the start end and the terminal end to identify whether the processing path is the forward path or the return path and identify the order of processing is set and stored regarding all processing regions R1 to Rn.

Moreover, the order-of-processing information 124 that is another embodiment of the order-of-processing information stored in the order-of-processing storing section 120 will be described. In the order-of-processing information 124, the first processing region in which the two-layer substrate W held by the chuck table 35 of the holding unit 3 is processed with scanning with the laser beam LB on the forward path indicated by the arrow XA is the above-described processing region R1 corresponding to the Y-coordinate of the one endmost part, and the X-coordinate and Y-coordinate of the start end P1 and the terminal end P2 are set. The first processing region to be processed in the direction of the return path indicated by the arrow XB is the processing region Rn-m corresponding to the Y-coordinate of a central part of the two-layer substrate W, and the X-coordinate and Y-coordinate of a start end P9 and a terminal end P10 are set. Further, the processing region to be processed on the next forward path is the processing region R2 adjacent to the inside (direction indicated by the arrow YA) of the processing region R1 at the one endmost part in the Y-axis direction, and the X-coordinate and Y-coordinate of the start end P5 and the terminal end P6 of irradiation and scanning with the laser beam LB are set. The processing region to be processed on the next return path is the processing region Rn-m+1 adjacent to the other endmost part side (direction indicated by an arrow YC) of the processing region Rn-m at the central part in the Y-axis direction, and the X-coordinate and Y-coordinate of a start end P11 and a terminal end P12 are set. As the processing regions of the forward path to be processed subsequently to them, the processing regions (R3 . . . ) that sequentially correspond to the inside (direction indicated by the arrow YA) of the two-layer substrate W are set. As the processing regions of the return path, the processing regions (Rn-m+2 . . . ) that sequentially correspond to the other end side of the workpiece are set. In addition, regarding all processing regions R1 to Rn, information regarding the X-coordinate and Y-coordinate of the start end and the terminal end to identify whether the processing path is the forward path or the return path and identify the order of processing is set and stored. In this manner, the X-coordinate and Y-coordinate of the start end and the terminal end to identify the order of processing are set and stored regarding all processing regions R1 to Rn.

The laser processing apparatus 1 of the present embodiment has a configuration that is substantially as described above. Laser processing executed with use of the laser processing apparatus 1 will be described below. The following description will be made on the basis of the assumption that the order-of-processing information stored in the above-described order-of-processing storing section 120 is the order-of-processing information 122 illustrated in FIG. 5.

After the two-layer substrate W described on the basis of FIGS. 1 and 2 is prepared, the two-layer substrate W is conveyed to the laser processing apparatus 1 and is placed over the holding surface 36 of the chuck table 35 of the holding unit 3 and is held under suction, and the annular frame is grasped and fixed by the clamps 37. Subsequently, the movement mechanism 4 is actuated, and the chuck table 35 is moved to a position directly under the imaging unit 7 and is imaged. Alignment to detect the outer edge of the two-layer substrate W, the position of the notch 10c, and the surface height is executed by the imaging unit 7.

On the basis of the information detected by the imaging unit 7, the chuck table 35 is moved to a position directly under the light collector 61 of the laser beam irradiation unit 6, and the notch 10c indicating the crystal orientation of the wafer 10 is positioned to the one end part side in the Y-axis direction.

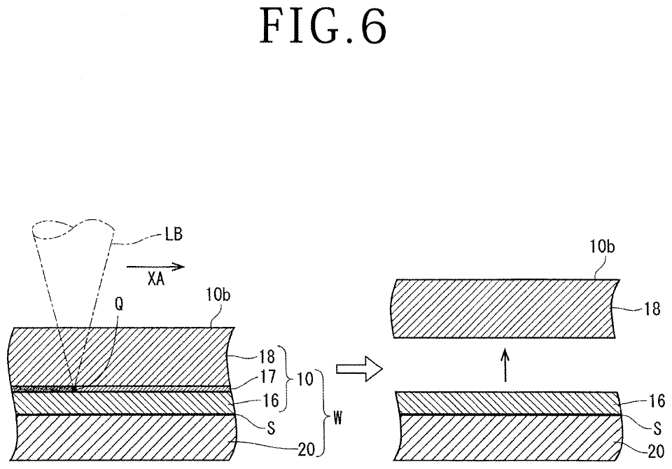

After the two-layer substrate W is moved to the position directly under the light collector 61 as described above, as illustrated in FIG. 6, a focal point Q of the laser beam LB with a wavelength having transmissibility with respect to the epitaxy substrate 18 and having absorbability with respect to the buffer layer 17 is positioned to the buffer layer 17 that interposes between the epitaxy substrate 18 and the optical device layer 16 that configure the wafer 10. Then, the laser oscillator 62, the X-axis galvano scanner 64, and the Y-axis galvano scanner 65 are actuated to execute the laser processing on the basis of the order-of-processing information 122 stored in the above-described order-of-processing storing section 120.

On the basis of information regarding the order-of-processing information 122 of the order-of-processing storing section 120, irradiation with the laser beam LB is executed from the side of the epitaxy substrate 18 and scanning with the laser beam LB is executed in a predetermined direction (in FIG. 6, forward path direction indicated by the arrow XA) to break the buffer layer 17 in the whole of the two-layer substrate W. Thereby, as illustrated on the right side in the diagram, processing of separating the epitaxy substrate 18 from the optical device layer 16 to transfer the optical device layer 16 to the side of the relocation substrate 20 is executed.

In the laser processing executed by the laser processing apparatus 1 of the present embodiment, the following laser processing conditions are set, for example.

Wavelength: 266 nm

Repetition frequency: 200 kHz

Average output power: 0.3 W

Pulse width: 10 ns

Spot diameter: 30 μm

As is understood from FIG. 5, in a case in which the order of processing of the processing region of the return path is set in the order-of-processing information 122, the Y-coordinate of the return path that is not adjacent to the processing region of the forward path to be processed immediately previously in the Y-axis direction is set. Thus, when processing is executed on the forward path in the X-axis direction by using the X-axis galvano scanner 64 and subsequently processing is executed on the return path in the X-axis direction, a load generated in the X-axis galvano scanner 64 that converts the movement direction of the laser beam LB is alleviated. Therefore, compared with a case in which the processing region of the return path adjacent to the processing region of the forward path to be processed immediately previously in the Y-axis direction is set, the problem that the lifetime of the X-axis galvano scanner 64 lowers due to a load of an inertial force generated in the X-axis galvano scanner 64 is resolved.

Although laser processing is executed on the basis of the order-of-processing information 122 illustrated in FIG. 5 in the above-described embodiment, laser processing may be executed on the basis of the above-described order-of-processing information 124. Also in the laser processing executed on the basis of the above-described order-of-processing information 124, when the order of processing of the processing region of the return path is set, the Y-coordinate of the return path that is not adjacent to the processing region of the forward path to be processed immediately previously in the Y-axis direction is set. Thus, when processing is executed on the forward path in the X-axis direction by using the X-axis galvano scanner 64 and subsequently processing is executed on the return path in the X-axis direction, a load generated in the X-axis galvano scanner 64 that converts the movement direction of the laser beam LB is alleviated. Therefore, compared with the case in which the processing region of the return path adjacent to the processing region of the forward path to be processed immediately previously in the Y-axis direction is set, the problem that the lifetime of the X-axis galvano scanner 64 lowers due to a load of an inertial force generated in the X-axis galvano scanner 64 is resolved.

The workpiece is the two-layer substrate W in the laser processing apparatus 1 of the above-described embodiment, and processing of breaking the buffer layer 17 in the whole of the two-layer substrate W and separating the epitaxy substrate 18 from the optical device layer 16 to transfer the optical device layer 16 to the side of the relocation substrate 20 is executed by using the laser processing apparatus 1 of the present embodiment. However, the present invention is not limited thereto. For example, with use of the laser processing apparatus 1 configured on the basis of the present invention, laser processing may be executed in which a wafer on which multiple devices are formed on a front surface in such a manner as to be marked out by multiple planned dividing lines that intersect is irradiated with a laser beam with a wavelength having absorbability with respect to the wafer along the planned dividing lines to execute ablation processing and divide the wafer into individual device chips. Further, laser processing may be executed in which, for a wafer on which multiple devices are formed on a front surface in such a manner as to be marked out by multiple planned dividing lines that intersect, the internal of the planned dividing line is irradiated with the focal point of a laser beam with a wavelength having transmissibility with respect to the wafer along the planned dividing lines to form a modified layer and form the origin of dividing for dividing the wafer into individual device chips.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A laser processing apparatus comprising:
a chuck table having a holding surface that holds a workpiece and is defined by an X-axis direction and a Y-axis direction; and
a laser beam irradiation unit that irradiates the workpiece held by the chuck table with a laser beam, wherein
the laser beam irradiation unit includes
a laser oscillator that emits the laser beam,
an X-axis galvano scanner that induces the laser beam emitted by the laser oscillator in the X-axis direction,
a Y-axis galvano scanner that induces the laser beam emitted by the laser oscillator in the Y-axis direction, and
a controller that controls the X-axis galvano scanner and the Y-axis galvano scanner,
the controller includes
a processing region storing section that stores an X-coordinate and Y-coordinate of processing regions in which the workpiece held by the chuck table is processed, and
an order-of-processing storing section that stores setting of order of processing of the processing region to be processed on a forward path through irradiation with the laser beam and the processing region of a return path to be subsequently processed, and,
in the setting of the order of processing, a Y-coordinate of the return path is set in such a manner that a load generated in the X-axis galvano scanner that converts a movement direction of the laser beam is alleviated when processing is executed on the forward path in the X-axis direction by using the X-axis galvano scanner and subsequently processing is executed on the return path in the X-axis direction.

2. The laser processing apparatus according to claim 1, wherein,
in the setting of the order of processing, when order of processing of the processing region of the return path is set, the processing region of the return path that is not adjacent to the processing region of the forward path to be processed immediately previously in the Y-axis direction is set.

3. The laser processing apparatus according to claim 2, wherein,
in the setting of the order of processing,
the processing region corresponding to a Y-coordinate of one endmost part is set as a first processing region in which the workpiece held by the chuck table is processed on the forward path, the processing region corresponding to a Y-coordinate of another endmost part is set as a first processing region to be processed on the return path, the processing region adjacent to an inside of the processing region at the one endmost part in the Y-axis direction is set as a processing region to be processed on the next forward path, and the processing region adjacent to an inside of the processing region at the other endmost part in the Y-axis direction is set as a processing region to be processed on the next return path, and
the processing regions that sequentially correspond to an inside of the workpiece in the Y-axis direction are set as the processing regions of the forward path and the processing regions of the return path.

4. The laser processing apparatus according to claim 2, wherein,
in the setting of the order of processing,
the processing region corresponding to a Y-coordinate of one endmost part is set as a first processing region in which the workpiece held by the chuck table is processed on the forward path, the processing region corresponding to a Y-coordinate of a central part is set as a first processing region to be processed on the return path, the processing region adjacent to an inside of the processing region at the one endmost part in the Y-axis direction is set as a processing region to be processed on the next forward path, and the processing region adjacent to another end part side of the processing region at the central part in the Y-axis direction is set as a processing region to be processed on the next return path, and
the processing regions that sequentially correspond to an inside of the workpiece in the Y-axis direction are set as the processing regions of the forward path, and the processing regions that sequentially correspond to the other end part side of the workpiece are set as the processing regions of the return path.
